(19) United States
(12) Patent Application Publication
(10) Pub. No.: US 2016/0005158 A1
(43) Pub. Date: Jan. 7, 2016

(54) IMAGE PROCESSING DEVICE AND IMAGE PROCESSING METHOD

(71) Applicant: Konica Minolta, Inc., Tokyo (JP)

(72) Inventor: Motohiro Asano, Osaka (JP)

(73) Assignee: Konica Minolta, Inc., Tokyo (JP)

(21) Appl. No.: 14/770,330

(22) PCT Filed: Feb. 4, 2014
(86) PCT No.: PCT/JP2014/052504

§ 371 Date: Aug. 25, 2015

(30) Foreign Application Priority Data
Feb. 26, 2013 (JP) 2013-035962

(51) Int. Cl. G06T 7/00; G06T 5/50; G06T 11/60; G06T 5/00

(52) U.S. Cl. CPC G06T 7/003; G06T 5/002; G06T 5/50; G06T 11/60; G06T 2207/10012; G06T 2207/20216

(57) ABSTRACT

An image processing device includes a setting unit that sets a search area according to a reference image based on an environmental condition, for each input image other than the reference image, using an image based on one input image, of a group of multi-viewpoint input images including a common sub-region, as the reference image, a positional deviation estimation unit that estimates positional deviation of each input image other than the reference image with respect to the reference image, by performing template matching processing in the search area, using the reference image, and a super-resolution processing unit that executes super-resolution processing, using the estimated positional deviation as a parameter.

### TECHNICAL FIELD

The invention relates to an image processing device and an image processing method, and especially relates to an image processing device and an image processing method, which perform processing of improving a resolution.

### BACKGROUND ART

There is an image processing technology of generating one high-resolution image from a group of multi-viewpoint input images having a low resolution and including a common sub-region. Such processing is called super-resolution processing.

If a pixel position to be used in the super-resolution processing is deviated in each input image, the resolution is not improved even if the super-resolution processing is applied to the group of input images.

For example, JP 2009-55410 A (hereinafter, Patent Literature 1) discloses a technology of detecting a rough moving amount (deviation amount) in a reduced image.

### CITATION LIST

### Patent Literature

Patent Literature 1: JP 2009-55410 A

### SUMMARY OF INVENTION

However, Patent Literature 1 does not use a difference in the viewpoint of each input image, and cannot appropriately handle the deviation of the pixel position in each input image when generating one high-resolution image from the group of multi-viewpoint input images. Therefore, even if the technology of Patent Literature 1 is used, the resolution is not improved even if the super-resolution processing is applied is not overcome, when the pixel position to be used in the super-resolution processing is deviated.

The invention may provide an image processing device and an image processing method that can suppress deterioration of image quality and can generate a high-resolution image.

According to an aspect of the invention, there is provided an image processing device that creates, from a group of multi-viewpoint input images having a common sub-region, a high-resolution image having higher frequency information than the input images, and outputs the high-resolution image, wherein a controller of the image processing device includes a setting unit for using one input image of the group of input images, as a reference image, and setting a search area according to the reference image, and based on an environmental condition, for each of the input images other than the reference image, an estimation unit for estimating positional deviation of each of the input images other than the reference image with respect to the reference image, by performing template matching processing in the search area, using the reference image, and a processing unit for executing super-resolution processing, for the input images, using the estimated positional deviation, as a parameter.

The setting unit sets the search area, based on a positional relationship between the viewpoint of the input image serving as the reference image, and the viewpoint of at least one input image of the input images other than the reference image, and the environmental condition.

The setting unit sets the search area to each of the input images other than the reference image, the search area being identified from a distance and a direction between the viewpoint of the reference image, and a most distance viewpoint of the multi-viewpoints, and a deformation ratio defined in the environmental condition in advance.

The setting unit sets the search area, based on distances and directions between the viewpoint of the input image serving as the reference image, and the viewpoints of the respective input images other than the reference image, and the environmental condition.

The setting unit uses the one input image of the input images other than the reference image, the one input image being selected according to the positional relationship with the viewpoint of the reference image, as a second reference image, and sets the search area for each of the input images other than the reference image and the second reference image, based on the positional deviation estimated for the second reference image.

The setting unit uses the search area according to the reference image based on the environmental condition, as a first search area, and sets an area including the first search area and a second search area for searching for the positional deviation based on a parallax from the reference image, as the search area, the second search area being set according to distances from the viewpoint of the input image serving as the reference image to the viewpoints of the respective input images other than the reference image.

The setting unit uses the input image having the viewpoint arranged at an inner side in the multi-viewpoints, of the group of input images, as the reference image.

The image processing device further includes: a degree of blur estimation unit for estimating the degree of blur of the input images, by adding blur according to the degree of blur to the reference image and generating the reference image, and performing the template matching processing, and the processing unit executes the super-resolution processing, further using the estimated degree of blur, as the parameter.

The group of input images is an image group obtained with a lens array including a plurality of lenses having a mutually different optical axis.

According to another aspect of the invention, there is provided an image processing method for generating, from a group of multi-viewpoint input images having a common sub-region, a high-resolution image having higher frequency information than the input images, as an output image, the method including the steps of: using one input image of the group of input images, as a reference image, and setting a search area according to the reference image and based on an environmental condition, for each of the input images other than the reference image; estimating positional deviation of each of the input images other than the reference image, with respect to the reference image, by performing template matching processing in the search area, using the reference image; and executing super-resolution processing, for the input images, using the estimated positional deviation, as a parameter.

According to yet another aspect of the invention, there is provided a program for causing a computer to execute processing of generating, from a group of multi-viewpoint input images having a common sub-region, a high-resolution image having higher frequency information than the input images, as an output image, the program for causing the computer to execute the steps of: using one input image of the group of input images, as a reference image, and setting a search area according to the reference image and based on an environmental condition, for each of the input images other than the reference image; estimating positional deviation of each of the input images other than the reference image, with respect to the reference image, by performing template matching processing in the search area, using the reference image; and executing super-resolution processing, for the input images, using the estimated positional deviation, as a parameter.

### ADVANTAGEOUS EFFECTS OF INVENTION

One or more embodiments of the invention may enable a high-resolution image to be generated while deterioration of image quality is suppressed, from a group of multi-viewpoint input images having a low resolution.

### BRIEF DESCRIPTION OF DRAWINGS

FIG. 1 is a block diagram illustrating a basic configuration of a configuration of an image processing device according to an embodiment.

FIG. 2 is a block diagram illustrating a configuration of a digital camera, which is an embodiment of the image processing device.

FIG. 3 is a block diagram illustrating a configuration of a personal computer, which is an embodiment of the image processing device.

FIG. 4 is a diagram illustrating a specific example of a layout of lenses included in a camera of the image processing device.

FIG. 5 is a diagram for describing an influence of temperature change of the lenses on super-resolution processing.

FIG. 6 is a diagram for describing an influence of temperature change of the lenses on super-resolution processing.

FIG. 7 is a diagram for describing an influence of temperature change of the lenses on super-resolution processing.

FIG. 8 is a flowchart illustrating a flow of an operation in the image processing device.

FIG. 9 is a diagram for describing deviation of pixel positions due to temperature change of an input image from respective lenses.

FIG. 10 is a diagram for describing a first specific example of positional deviation rough estimation processing as first positional deviation estimation processing at step S1 of FIG. 8.

FIG. 11 is a diagram for describing positional deviation estimation processing as second positional deviation estimation processing at step S2 of FIG. 8.

FIG. 12 is a diagram for describing the positional deviation estimation processing as the second positional deviation estimation processing at step S2 of FIG. 8

FIG. 13 is a diagram for describing the positional deviation estimation processing as the second positional deviation estimation processing at step S2 of FIG. 8

FIG. 14 is a diagram illustrating a flow of super-resolution processing at step S3 of FIG. 8.

FIG. 15 is a diagram for describing deterioration information used at step #33 of FIG. 14.

FIG. 16 is a diagram illustrating a specific example of the deterioration information.

FIG. 17 is a diagram illustrating another example of the super-resolution processing at step S3 of FIG. 8.

FIG. 18 is a diagram illustrating a second example of the positional deviation rough estimation processing.

FIG. 19 is a diagram illustrating the second example of the positional deviation rough estimation processing.

FIG. 20 is a diagram illustrating the second example of the positional deviation rough estimation processing.

FIG. 21 is a diagram illustrating a third example of the positional deviation rough estimation processing.

FIG. 22 is a diagram illustrating the third example of the positional deviation rough estimation processing.

FIG. 23 is a diagram illustrating the third example of the positional deviation rough estimation processing.

FIG. 24 is a diagram illustrating the third example of the positional deviation rough estimation processing.

FIG. 25 is a diagram illustrating a fourth example of the positional deviation rough estimation processing.

FIG. 26 is a diagram illustrating the fourth example of the positional deviation rough estimation processing.

FIG. 27 is a diagram illustrating the fourth example of the positional deviation rough estimation processing.

FIG. 28 is a diagram illustrating the fourth example of the positional deviation rough estimation processing.

FIG. 29 is a diagram illustrating the fourth example of the positional deviation rough estimation processing.

FIG. 30 is a diagram illustrating the fourth example of the positional deviation rough estimation processing.

FIG. 31 is a block diagram illustrating a basic configuration example of a configuration of an image processing device according to a second modification.

FIG. 32 is a diagram for describing a second modification of positional deviation estimation processing at step S2 of FIG. 8.

FIG. 33 is a diagram for describing the second modification of positional deviation estimation processing at step S2 of FIG. 8.

FIG. 34 is a diagram for describing the second modification of positional deviation estimation processing at step S2 of FIG. 8.

FIG. 35 is a diagram for describing the second modification of the positional deviation estimation processing at step S2 of FIG. 8.

FIG. 36 is a diagram for describing the second modification of the positional deviation estimation processing at step S2 of FIG. 8.

FIG. 37 is a flowchart illustrating processing for calculation of a parameter performed prior to the super-resolution processing of step S3 of FIG. 8.

FIG. 38 is a diagram for describing a method of converting coefficients of a Gaussian filter at step #11 of FIG. 37.

FIG. 39 is a diagram for describing a method of calculating a PSF at step #12 of FIG. 37.

### DESCRIPTION OF EMBODIMENTS

Hereinafter, embodiments of the invention will be described with reference to the drawings. In the description below, the same parts or configuration elements are denoted with the same reference sign. Names and functions thereof are also the same. Therefore, repetitive description is not provided.

<System Configuration>

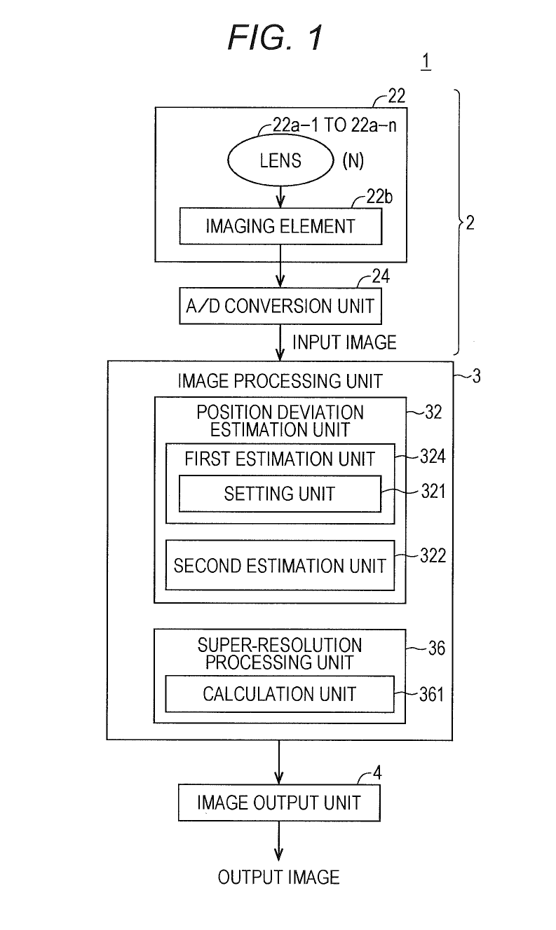

FIG. 1 is a block diagram illustrating a basic configuration of a configuration of an image processing device 1 according to embodiments.

Referring to FIG. 1, an image processing device 1 includes an imaging unit 2, an image processing unit 3, and an image output unit 4. In the image processing device 1 illustrated in FIG. 1, the imaging unit 2 acquires an image (hereinafter, may also be referred to as “input image”) by imaging of a subject, and the image processing unit 3 generates a high-resolution output image having a higher frequency component than the input image (hereinafter, the high-resolution output image may also be referred to as “high-resolution image”) by applying image processing as described below to the acquired input image. Then, the image output unit 4 outputs the high-resolution image to a display device or the like.

The imaging unit 2 images the object (subject) to generate the input image. To be specific, the imaging unit 2 includes a camera 22 and an analog to digital (A/D) converter 24 connected with the camera 22. The A/D converter 24 outputs the input image, which indicates the subject imaged by the camera 22.

The camera 22 is an optical system for imaging the subject, and is an array camera. That is, the camera 22 includes N lenses 22a-1 to 22a-n having different viewpoints and arranged in a grid-like manner (may also be referred to as lens 22a, representing the N lenses 22a-1 to 22a-n), and an imaging element (image sensor) 22b that is a device that converts an optical image formed by the lens 22a into an electrical signal.

The A/D converter 24 converts a video signal (analog electrical signal), which indicates the subject and output from the imaging element 22b, into a digital signal and outputs the digital signal. The imaging unit 2 can further include a control processing circuit for controlling respective units of the camera.

The image processing unit 3 generates a high-resolution image by performing an image processing method according to embodiments, for the input image acquired by the imaging unit 2. To be specific, the image processing unit 3 includes a positional deviation estimation unit 32 for performing positional deviation estimation processing described below and a super-resolution processing unit 36. The positional deviation estimation unit 32 further includes a first estimation unit 324 for performing first positional deviation estimation processing and a second estimation unit 322 for performing second positional deviation estimation processing. The first estimation unit 324 further includes a setting unit 321 for setting a search area described below. Further, the super-resolution processing unit 36 includes a calculation unit 361 for calculating a parameter to be used in super-resolution processing, based on estimated positional deviation and the like.

The super-resolution processing unit 36 performs the super-resolution processing described below for the input image. The super-resolution processing is processing of generating frequency information exceeding a Nyquist frequency that the input image has. At that time, the positional deviation estimation unit 32 performs the first positional deviation estimation processing and the second positional deviation estimation processing described below to estimate positional deviation from a reference image, for each input image.

The image output unit 4 outputs the high-resolution image generated by the image processing unit 3 to a display device and the like.

The image processing device 1 illustrated in FIG. 1 can be configured as a system in which respective units are embodied by independent devices. However, for general use, the image processing device 1 is often embodied as a digital camera or a personal computer described below. Therefore, as an embodied example of the image processing device 1 according to embodiments, an embodied example as a digital camera and an embodied example as a personal computer (PC) will be described.

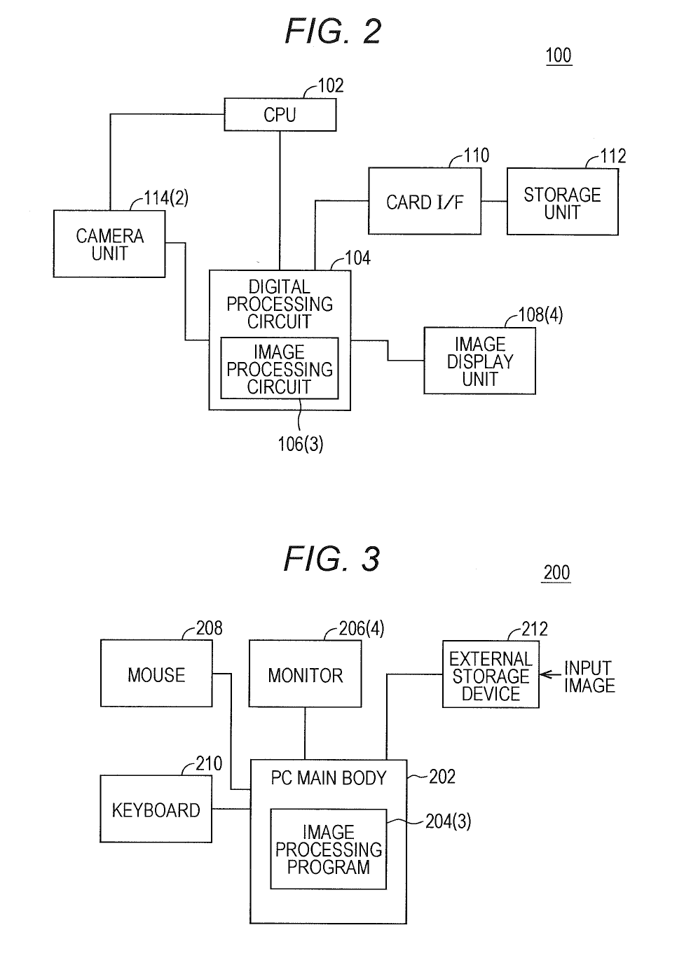

FIG. 2 is a block diagram illustrating a configuration of a digital camera 100 of the image processing device 1 illustrated in FIG. 1. In FIG. 2, components corresponding to respective blocks that configure the image processing device 1 illustrated in FIG. 1 are denoted with the same reference signs as FIG. 1.

Referring to FIG. 2, the digital camera 100 includes a central processing unit (CPU) 102, a digital processing circuit 104, an image display unit 108, a card interface (I/F) 110, a storage unit 112, and a camera unit 114.

The CPU 102 controls the entire digital camera 100 by executing a program and the like stored in advance. The digital processing circuit 104 executes various types of digital processing including image processing in accordance with one or more embodiments. The digital processing circuit 104 is typically configured from, a digital signal processor (DSP), an application specific integrated circuit (ASIC), a large scale integration (LSI), a field-programmable gate array (FPGA), and the like. The digital processing circuit 104 includes an image processing circuit 106 for realizing the function provided by the image processing unit 3 illustrated in FIG. 1.

The image display unit 108 displays an input image provided by the camera unit 114, an output image generated by the digital processing circuit 104 (image processing circuit 106), various types of setting information related to the digital camera 100, a control graphical user interface (GUI) screen, and the like.

The card interface (I/F) 110 is an interface for writing image data generated by the image processing circuit 106 to the storage unit 112, and reading image data and the like from the storage unit 112. The storage unit 112 is a storage device that stores the image data generated by the image processing circuit 106 and various types of information (setting values such as a control parameter and an operation mode of the digital camera 100). The storage unit 112 is made of a flash memory, an optical disk, a magnetic disk, or the like, and stores the data in a non-volatile manner.

The camera unit 114 generates the input image by imaging the subject.

The digital camera 100 illustrated in FIG. 2 is an implementation of the entire image processing device 1 in accordance with one or more embodiments, as a single-body device. That is, a user can visually recognize a high-resolution image in the image display unit 108 by imaging the subject using the digital camera 100.

FIG. 3 is a block diagram illustrating a configuration of a personal computer 200 of the image processing device 1 illustrated in FIG. 1. The personal computer 200 illustrated in FIG. 3 is an implementation of a part of the image processing device 1 in accordance with one or more embodiments, as a single-body device. The personal computer 200 illustrated in FIG. 3 is configured such that the imaging unit 2 for acquiring an input image is not mounted, and an input image acquired by an arbitrary imaging unit 2 is input from an outside. Even such a configuration can be included in the image processing device 1 in accordance with one or more embodiments. Note that, in FIG. 3, components corresponding to the respective blocks that configure the image processing device 1 illustrated in FIG. 1 are denoted with the same reference sign as FIG. 1.

Referring to FIG. 3, the personal computer 200 includes a personal computer main body 202, a monitor 206, a mouse 208, a keyboard 210, and an external storage device 212.

The personal computer main body 202 is typically a general-purpose computer complying with general-purpose architecture, and includes, as basic configuration elements, a CPU, a random access memory (RAM), a read only memory (ROM), and the like. The personal computer main body 202 can execute an image processing program 204 for realizing the function provided by the image processing unit 3 illustrated in FIG. 1. Such an image processing program 204 is circulated by being stored in a storage medium such as a compact disk-read only memory (CD-ROM), or distributed from a server device through a network. Then, the image processing program 204 is stored in a storage area of a hard disk of the personal computer main body 202, or the like.

Such an image processing program 204 may be configured to call necessary modules, of program modules provided as a part of an operating system (OS) executed in the personal computer main body 202, in order at predetermined timing to realize processing. In this case, the image processing program 204 per se does not include the modules provided by the OS, and realizes the image processing in cooperation with the OS. Further, the image processing program 204 is not a single-body program, and may be provided by being incorporated in a part of some sort of program. In such a case, the image processing program 204 per se does not include a module commonly used in the some sort of program, and realize the image processing in cooperation with the some sort of program. Even such an image processing program 204 that does not include a part of the modules does not depart from the gist of the image processing device 1 in accordance with one or more embodiments.

Apparently, a part or all of the functions provided by the image processing program 204 may be realized by dedicated hardware.

The monitor 206 displays a GUI screen provided by the operating system (OS), the image generated by the image processing program 204, and the like.

The mouse 208 and the keyboard 210 receive user operations, and output content of the received user operations to the personal computer main body 202.

The external storage device 212 stores an input image acquired by some sort of method, and outputs the input image to the personal computer main body 202.

As the external storage device 212, a device that stores data in a non-volatile manner, such as a flash memory, an optical disk, or a magnetic disk, is used.

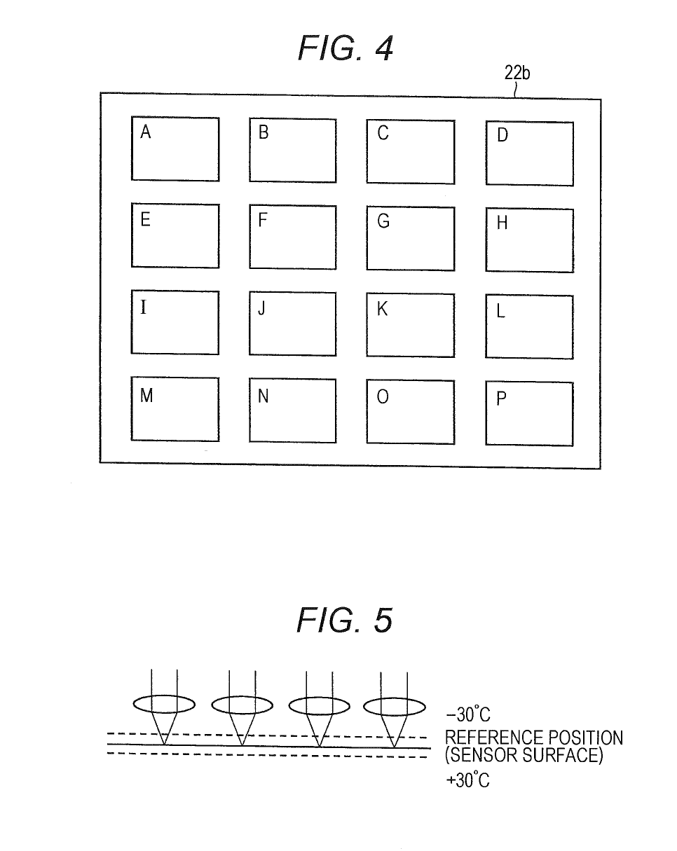

FIG. 4 is a diagram illustrating a specific example of a layout of the lens 22a included in the camera 22. In the example of FIG. 4, the camera 22 is an array camera including sixteen lenses 22a-1 to 22a-16 (lens A to P) arranged in a grid-like manner, as an example. Intervals (base line lengths) among the lenses A to P of FIG. 4 are uniform in both of a vertical direction and a horizontal direction. Note that input images A, B, C, D, E, F, G, H, I, J, K, L, M, N, O, P from the camera 22 of when the camera 22 performs imaging represent input images from the lenses A to P, respectively.

<Outline of Operation>

Members of the lens 22a and the like may be deformed depending on an environmental condition. Especially, when the lens 22a, a member that holds the lens 22a, and the like are formed of a material such as plastic, which is susceptible to an influence, a deformation ratio thereof is large. Therefore, the input image is subject to an influence of the deformation, and the super-resolution processing using the input image is subject to the influence. Note that examples of the environmental condition include temperature and humidity, for example, and temperature change will be exemplified in the description below.

FIGS. 5 to 7 are diagrams for describing an influence of the temperature change of the lenses on the super-resolution processing. In more detail, referring to FIG. 5, there is an influence that a distance between the lens 22a and the imaging element (image sensor) 22b is changed due to the temperature change of the lenses, and the input image is blurred accordingly, as a first influence. For example, when the position of the lens 22a at which focal points from the respective lenses are positioned on a sensor surface of the imaging element 22b is a reference position, the focal points are deviated from the reference position by about 15 to 20 μm due to the temperature change of 30° C. with respect to the lenses, and thus an image sensed in the imaging element 22b is blurred. Note that, in this case, deviation amounts of the focal points from the reference position may slightly differ depending on a color.

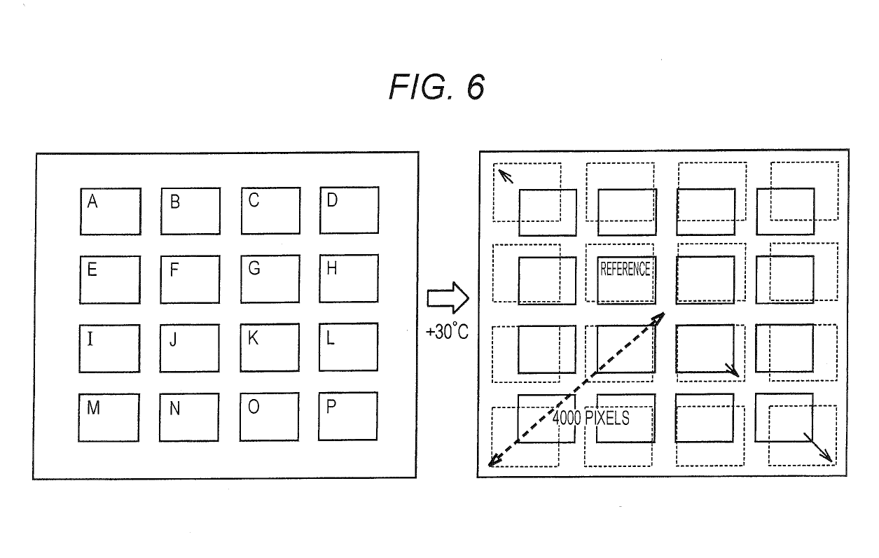

Further, referring to FIG. 6, there is an influence that a lens pitch (the position of a lens) is changed depending on the temperature change of the member that holds the lens 22a, and the pixel position in the input image is deviated, accordingly, as a second influence. For example, when there is an increase in the temperature of 30° C. with respect to the member that holds the lens 22a, the position of a lens is changed such that a lens arranged at an outer side is moved outward by a larger moving distance, as illustrated in FIG. 6. Accordingly, the pixel position used in the super-resolution processing in each input image is deviated from a predetermined position.

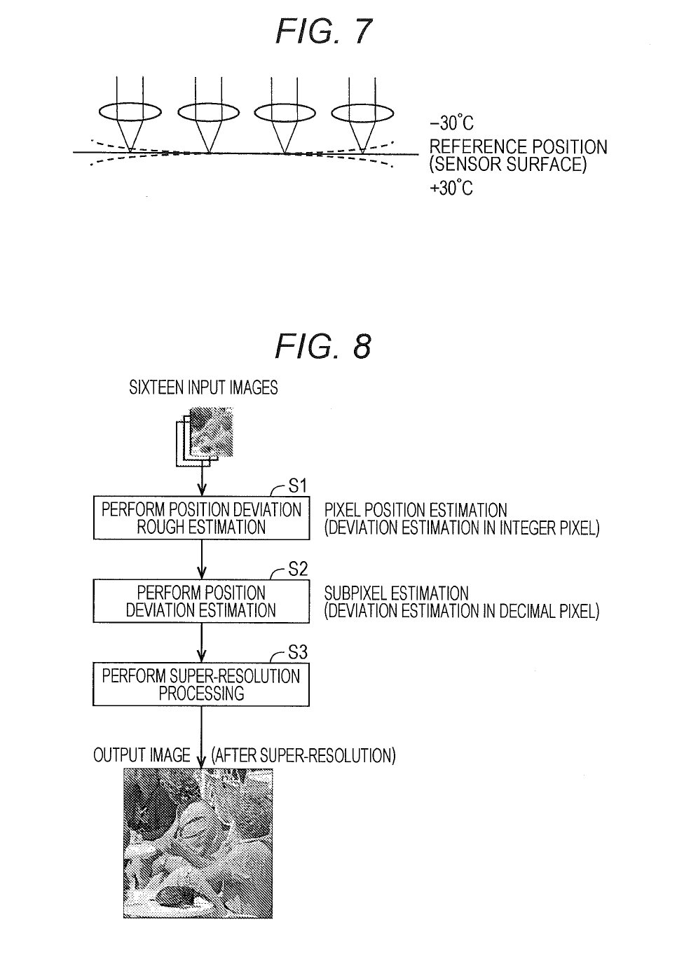

Further, referring to FIG. 7, there is an influence that the sensor surface is deformed (bends) due to the temperature change of the imaging element (image sensor) 22b, and a part of the input images or a region in one input image, of the group of the input images from the lens 22a, is blurred, accordingly, as a third influence. For example, when the position of the lens 22a with which the focal points from the respective lenses are positioned on the sensor surface of the imaging element 22b, the sensor surface is deformed to bend from a reference position, as illustrated in FIG. 7, when there is temperature change of 30° C. in the imaging element 22b. Accordingly, the way of blurring (the degree of blur) in each input image is changed axially symmetric to the group of the input images.

Regarding the influence of the deformation on the input images due to the temperature change of the members such as the lens 22a, the first influence illustrated in FIG. 5 is the largest, and basically, blur is included in all of the input images without exception. Meanwhile, in the example illustrated in FIG. 7, the degree of blur is different in each input image or each region in the input image because of a difference of each lens position.

(Operation Outline)

In the image processing device 1, the super-resolution processing is applied to the plurality of input images having different viewpoints, which is obtained by imaging a subject by the camera 22 as an array camera, and a high-resolution image is obtained. At this time, the image processing device 1 performs the super-resolution processing in consideration of the deviation of the pixel positions due to the environmental conditions (the temperature change and the like) in the respective input images, as illustrated in FIG. 6.

<Operation Flow>

(Overall Operation)

FIG. 8 is a flowchart illustrating a flow of an operation in the image processing device 1 in accordance with one or more embodiments. Referring to FIG. 8, first, in the image processing device 1, processing of acquiring the input images in the respective lenses of the lens 22a is executed, so that sixteen input images are acquired. Here, low-resolution images of about 1000×750 pixels are input, for example.

When the input images are acquired, the positional deviation rough estimation processing is executed as the first positional deviation estimation processing (step S1). Here, the deviation amount in units of pixel (integer pixel) is estimated. Note that, here, the positional deviation of a pixel of each input image due to change of the position of the lens 22a due to the temperature change is estimated.

Next, the second positional deviation estimation processing is executed based on the deviation amount in units of pixel (step S2). Here, the deviation amount in units of sub-pixel (decimal pixel) is estimated.

Then, the super-resolution processing is executed in consideration of the positional deviation amount (step S3), and a high-resolution image of about 4000×3000 pixels is generated as the output image.

(Positional Deviation Rough Estimation)

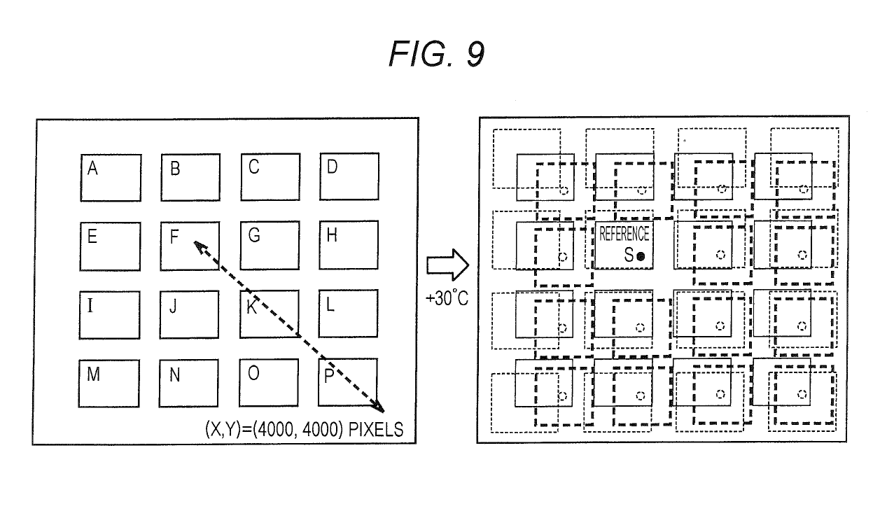

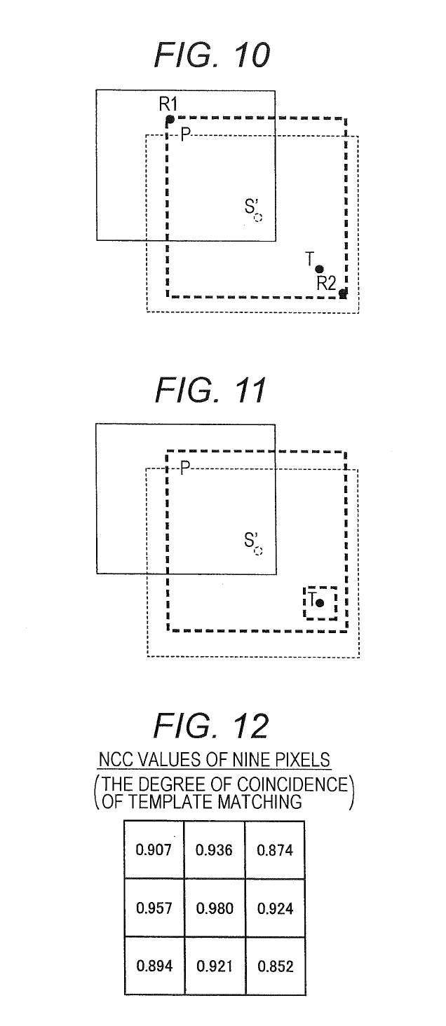

FIGS. 9 and 10 are diagrams for describing a first specific example of the positional deviation rough estimation processing as the first positional deviation estimation processing at step S1 described above. FIG. 9 is a diagram for describing deviation of the pixel positions of the input images from the respective lenses of the lens 22a due to the temperature change, and is a diagram schematically illustrating the input images of when the temperature is increased by 30° C., as an example. In the diagram before the increase in the temperature (the left diagram) of FIG. 9, the sixteen rectangles with the solid lines respectively illustrate the input images A to P before the increase in the temperature. In the diagram after the increase in the temperature of FIG. 9 (the right diagram), the sixteen rectangles with the narrow lines respectively illustrate the input images A to P before the increase in the temperature, and the sixteen rectangles with the dotted lines respectively illustrate the input images A to P after the increase in the temperature.

Referring to FIG. 9, when the temperature is increased, the lenses of the lens 22a and the member (not illustrated) that holds the lens 22a expand. Therefore, an imaging range of each input image is enlarged around the center in an overall manner. The deviation of the position of the lens 22a due to the temperature is smaller in a lens arranged at an inner side, and is larger in a lens arranged at an outer side. Therefore, the deviation of the input image from the lens arranged at an inner side (for example, the lens F. G, J, or K) from before the increase in the temperature is smaller than the deviation of the input image from the lens arranged at an outer side (for example, the lenses A to E, H, I, or L to P). Therefore, the image processing device 1 uses the input image from the lens arranged at an inner side, as the reference image at step S1. In the following example, the input image F from the lens F arranged at an inner side is used as the reference image. In this case, the position of the input image P from the lens P arranged in a position most separated from the lens F is most largely deviated.

As illustrated in the example of FIG. 9, an extension of the position on the input image is 1/1000 times with respect to the increase in the temperature of 30° C., as an example. In this case, the input image P is changed in a diagonal direction (in each of an X direction and a Y direction) by 4 pixels due to the temperature change of 30° C., where the distance between the input image F as the reference image and the input image P is 4000 pixels in the diagonal direction (in each of the X direction and the Y direction), that is, the input image P is changed within a range of 9×9 pixels.

At step S1 described above, the positional deviation of a pixel (reference pixel) S on the input image F as the reference image is estimated, which is illustrated by the black circle in FIG. 9. Referring to FIG. 10, a corresponding pixel S′ of the input image P (the circle with the dotted line) of a case where no positional deviation due to the temperature change occurs is identified, the viewpoint of the input image P being most separated from the input image F as the reference image. Then, when the positional deviation in the temperature change of 30° C. is estimated, a range of change of the pixels at 30° C. is set as an area (search area) for searching for a pixel corresponding to the reference pixel S, around the pixel S′. That is, referring to FIG. 10, a pixel R1 being positioned corresponding to the pixel S° when the temperature is decreased by 30° C. and a pixel R2 of when the temperature is increased by 30° C. are identified from the amount of change and the direction of change, and a rectangle having the pixel R1 and the pixel R2 as diagonals (the rectangle with the bold line) is set as the search area.

Note that, as the search area, an area broader than an area set only from the temperature change may be set in consideration of deviation from a design value, such as an actual distance between the lenses of the lens 22a, in addition to the temperature change.

Template matching processing is performed using an image including the reference pixel S of the input image F within the search area, and a pixel T having a highest degree of coincidence with the reference pixel S is identified as a pixel being positioned corresponding to the reference pixel S. An example of the template matching processing here includes normalized cross correlation (NCC). As other examples, sum of absolute difference (SAD) or sum of squared difference (SSD) may be employed. At step S1 described above, the above-described processing is performed for each pixel of the input image F, so that a pixel to be used in the super-resolution processing is detected, for each input image. That is, as illustrated in the right diagram of FIG. 9, the search area set for the input image P, as illustrated in FIG. 10 is similarly set for the input images other than the input image F serving as a image to be calculated and the input image P. Then, the above-described template matching processing is performed for the search area of each input image, and the pixel being positioned corresponding to the reference pixel S in each input image is identified.

(Positional Deviation Estimation)

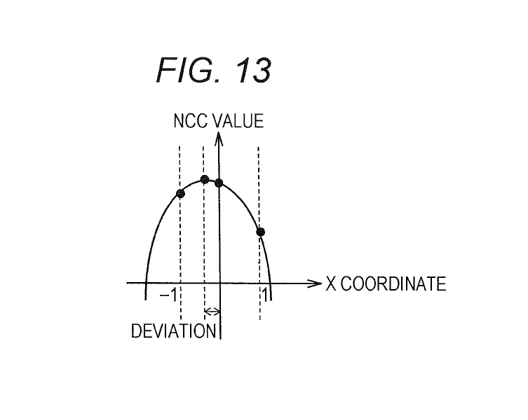

FIGS. 11 to 13 are diagrams for describing the positional deviation estimation processing as the second positional deviation estimation processing at step S2 described above. Referring to FIG. 11, quadric surface fitting is performed for the input image P as the referred image (the rectangle with the dotted line) after the temperature change, and the positional deviation in units of sub-pixel is estimated. The quadric surface fitting is performed based on the degree of coincidence (for example, the NCC value) of each pixel in the template matching (FIG. 12), in a predetermined range (the rectangle with the bold line) based on the pixel T, such as a range of 3×3 pixels around the pixel T corresponding to the reference pixel S of the input image F, the reference pixel S being identified in the first positional deviation estimation processing of step S1 described above. In the positional deviation estimation of step S2, a technique described in the paper “A Robust Super-Resolution Based on Local Similarity and Displacement” (Journal of THE INSTITUTE OF ELECTRONICS, INFORMATION AND COMMUNICATION ENGINEERS, Vol. J92-D, No. 5, pp. 650-660, 2009, May 2009), illustrated in FIG. 13, can be employed as an example. That is, as illustrated in FIGS. 12 and 13, coordinates of the pixel having the highest degree of coincidence, of the degrees of coincidence of the pixels, are identified as the deviation amount.

Note that, at step S2, another technique such as fitting to a quadratic curve in each of an X coordinate and a Y coordinate may be employed, in place of the above-described quadric surface fitting.

(Super-Resolution Processing)

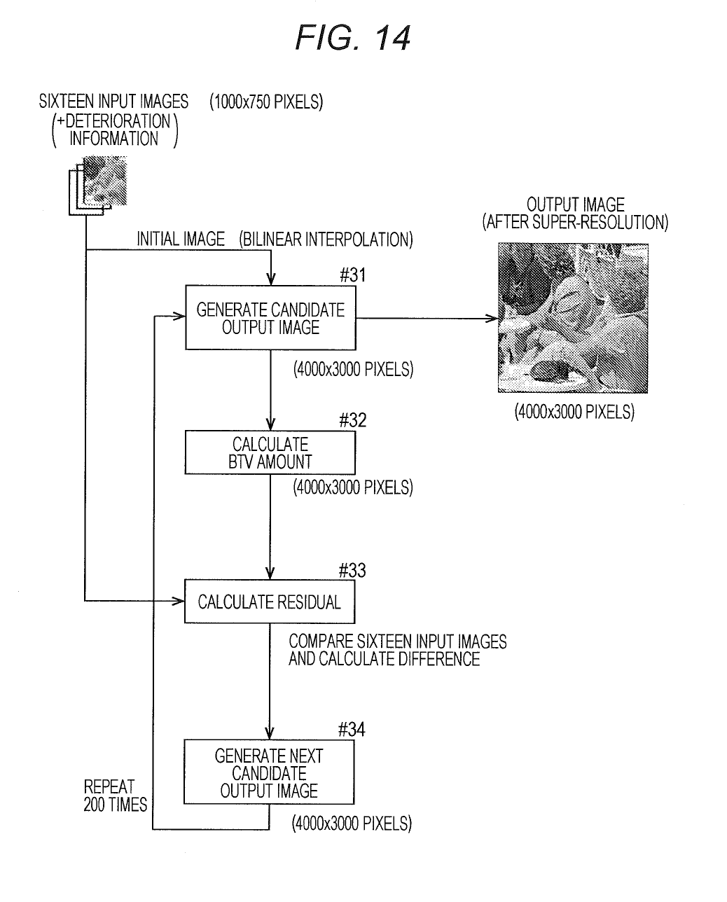

FIG. 14 is a diagram illustrating a flow of the super-resolution processing at step S3 described above. In FIG. 14, as a specific example, a flow of the super-resolution processing of when processing described in the paper “Fast and Robust Multiframe Super Resolution” (IEEE TRANSACTIONS ON IMAGE PROCESSING, VOL. 13, NO. 10, October 2004 page. 1327-1344) is performed is illustrated.

Referring to FIG. 14, at step #31, interpolation processing such as bilinear method is applied to one of the input images, and the resolution of the input image is converted into the high-resolution that is the resolution after the super-resolution processing, so that a candidate output image as an initial image is generated.

At step #32, a bilateral total variation (BTV) amount for causing images to converge in a robust manner against noises is calculated.

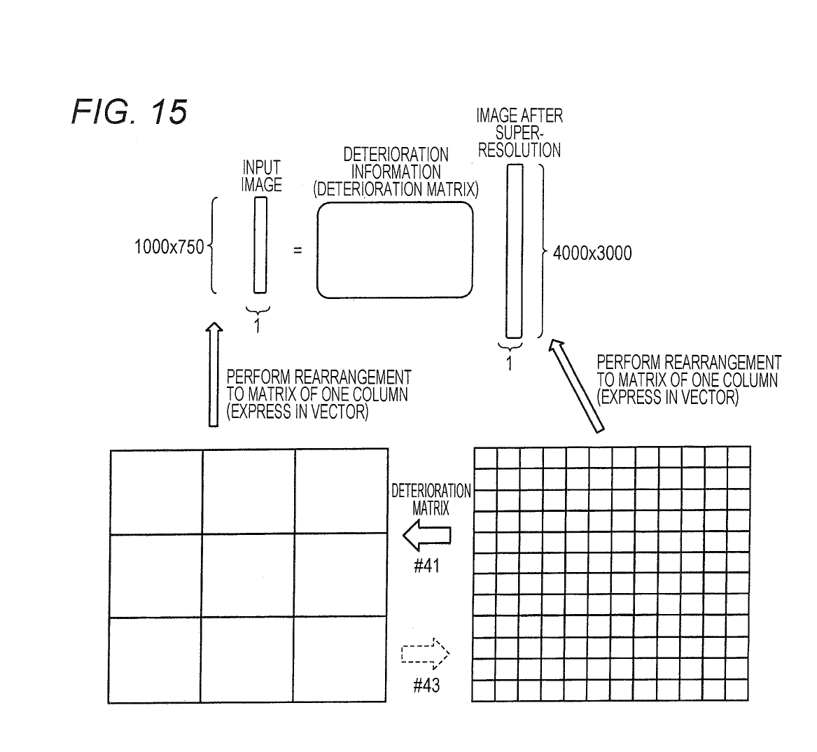

At step #33, the above-described generated candidate output image and the sixteen input images are compared, and a residual is calculated. That is, at step #33, the generated candidate output image is converted into an input image size (converted into a low resolution), based on the input images and its deterioration information (information indicating a relationship between the image after super resolution and the input images) (#41 of FIG. 15), and a difference between the candidate output image and the sixteen input images is calculated and recorded. Then, the difference is returned to a size after the super-resolution processing (#43 of FIG. 15), and is used as the residual.

At step #34, the calculated residual and the BTV amount are subtracted from the candidate output image generated at step #31, and a next candidate output image is generated.

The processing of steps #31 to #34 described above is repeated until the candidate output image converges, and the candidate output image that has converged is output as the output image after the super-resolution processing.

The repetition may be performed by a predetermined number such as the number by which the convergence is nearly sufficiently performed (for example, 200 times), or may be performed according to a result of determination of the convergence, which is performed every time of a series of processing.

FIG. 15 is a diagram for describing deterioration information used in step #33 described above.

The deterioration information refers to information indicating a relationship between each input image and the high-resolution image after the super-resolution processing, and is expressed in a matrix form, for example. The deterioration information includes the deviation amount at a sub-pixel level, a down-sampling amount, and a blur amount of each input image estimated at step S2 described above.

Referring to FIG. 15, the deterioration information is defined in a matrix that indicates conversion, when the input images and the high-resolution image after the super-resolution processing are respectively expressed in one-dimensional vectors. The image processing device 1 calculates a parameter to be used in the super-resolution processing, based on the positional deviation estimated in the estimation processing of steps S1 and S2 described above, and incorporates the parameter as the deterioration information.

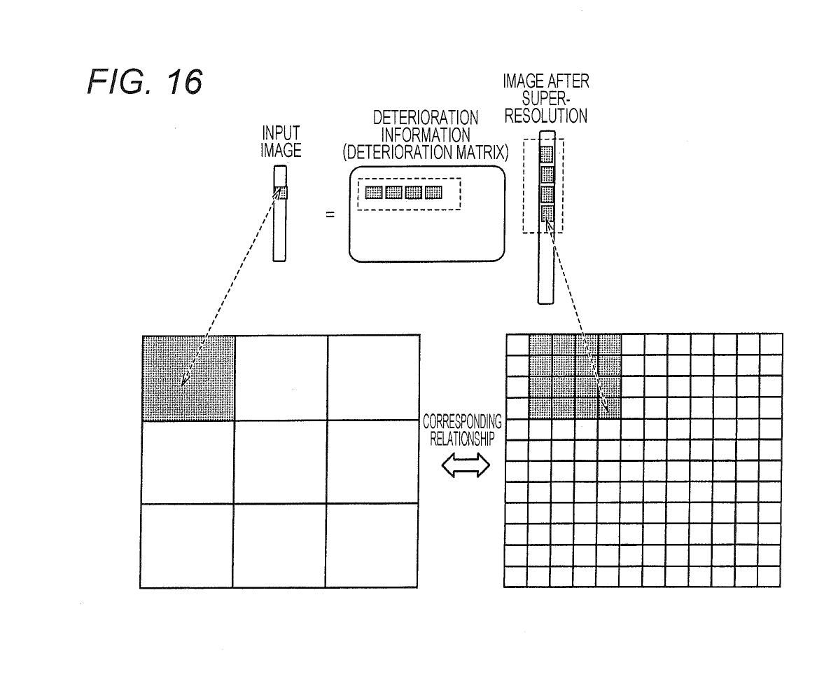

FIG. 16 is a diagram illustrating a specific example of the deterioration information. The image processing device 1 defines the deterioration information as illustrated in FIG. 16, when the deviation amount of the pixel is estimated as 0.25 pixels, and the down-sampling amount is ¼ in each of the vertical direction and the horizontal direction. When one place corresponding to one pixel in the input image, and sixteen pixels in sixteen places in the high-resolution image after the super-resolution processing correspond to each other, a coefficient of 1/16 is described in the sixteen places in the deterioration information. Therefore, when the deviation amount of the pixel is 0.25 pixels, the 1/16 of the deviation amount contributes to each of the sixteen pixels of the high-resolution image.

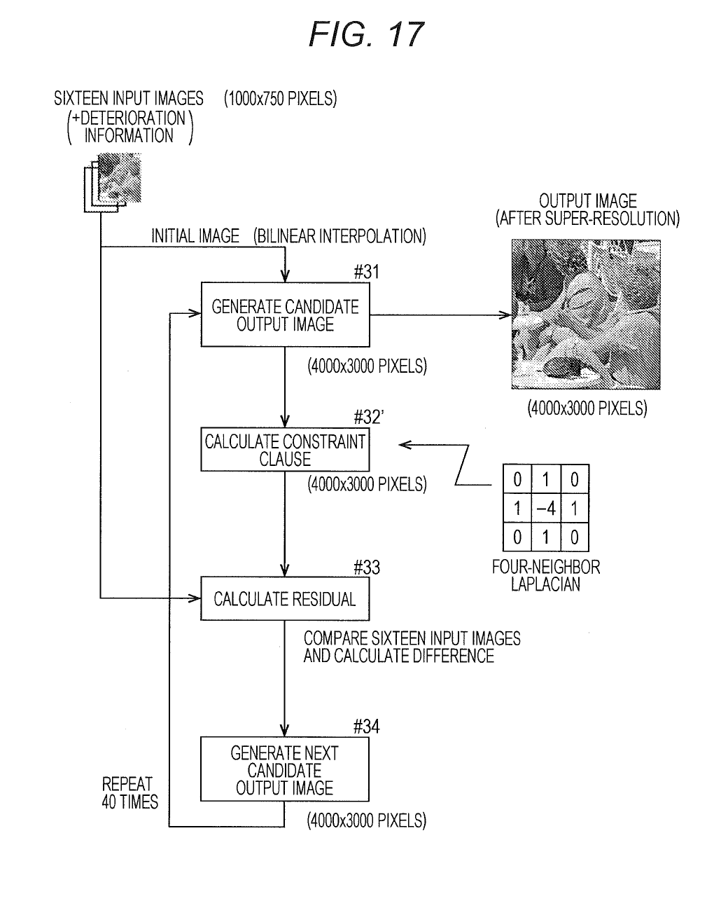

Note that the super-resolution processing at step S3 described above is not limited to the processing illustrated in FIG. 14, and another processing may be employed as long as the processing is reconstruction type super-resolution processing of generating one image from a plurality of input images. FIG. 17 is a diagram illustrating another example of the super-resolution processing at step S3 described above. That is, referring to FIG. 17, for a constraint clause calculated at step S32 described above, another value such as four-neighbor Laplacian may be used (step #32′), in place of a BTV amount.

[First Modification]

The positional deviation rough estimation processing at step S1 described above is not limited to the processing illustrated in FIGS. 9 and 10. That is, in the processing illustrated in FIGS. 9 and 10 in the positional deviation rough estimation processing, the search area is identified from the distance and the direction between the viewpoint (lens F) of the reference image F and the most distant viewpoint (lens P), and the deformation ratio defined for the environmental condition (temperature change) in advance, and the search area is set to each of the input images A to E, and G to P, other than the reference image F. However, the search area may be set by a method other than the above-described method, as long as the search area is set based on positional relationship between a viewpoint of an input image serving as a reference image and a viewpoint of at least one input image, of input images other than the reference image, and an environmental condition (temperature change).

As another example of positional deviation rough estimation processing, the search area may be set based on a distance and a direction between a viewpoint of an input image serving as a reference image and viewpoints of respective input images other than the reference image, and an environmental condition (temperature change). That is, a deviation amount of a pixel of each input image become large according to the distance from the reference image (the distance between lenses of a lens 22a), and a deviating direction is determined according to the positional relationship of the lens 22a. Therefore, a different search area may be set for each input image.

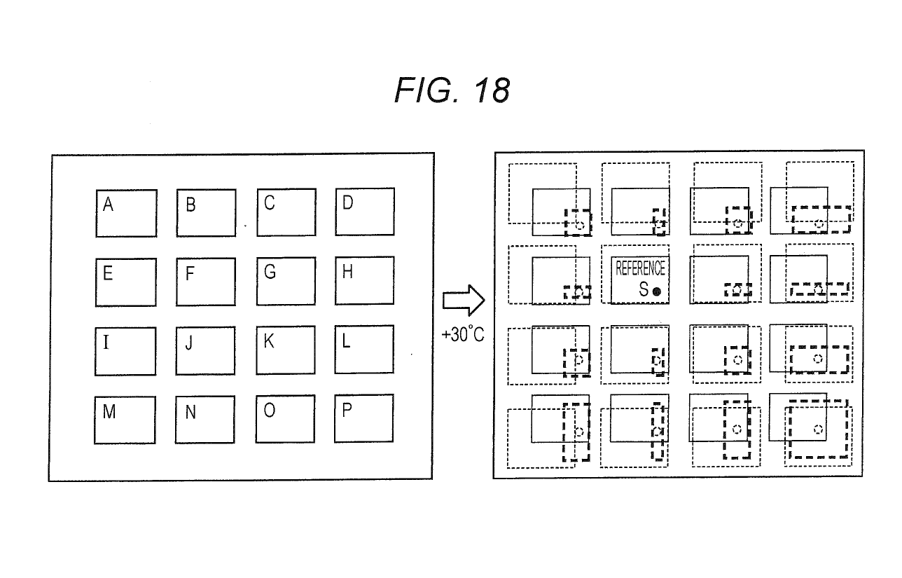

FIGS. 18 to 20 are diagrams illustrating a second example of positional deviation rough estimation processing. In the second example of positional deviation rough estimation processing, as illustrated in the right diagram of FIG. 18, a search area is set for each input image, based on a distance and a direction between a viewpoint (lens F) of a reference image F and a viewpoint (lens).

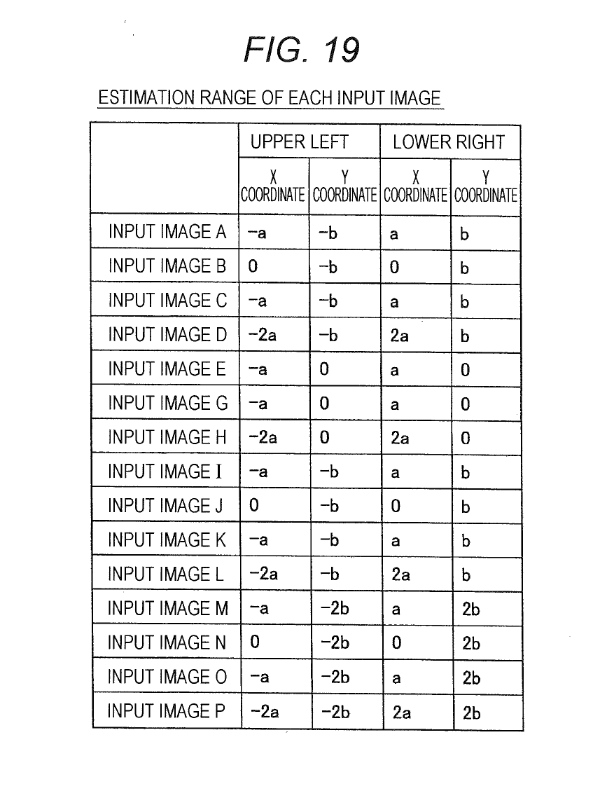

As illustrated in FIG. 19 as an example, search areas in respective input images with respect to the reference image may be defined in advance, for each temperature change, and an image processing device 1 may set the search areas according to the temperature change to the respective input images. That is, when there is no positional deviation of each input image due to the temperature change, an area around a position of a pixel S′ corresponding to a reference pixel S, which is read from FIG. 19, may be set as the search area (the right diagram of FIG. 18). As illustrated in FIGS. 18 and 19, the search area is broader as the input image is more distant from the reference image, and is set longer in a radial direction. Note that, a calculation formula for calculating search areas may be stored in advance, based on the temperature change and (viewpoints of) the input images with respect to the reference image, and the image processing device 1 may calculate the search areas of the respective input images by inputting the temperature change and the viewpoints of the input images, and set the search areas to the respective input images, in place of the relationship of FIG. 19. Even in this calculation formula, the search area is broader as the input image is more distant from the reference image, and a longer search area is calculated in the radial direction, as illustrated in FIGS. 18 and 19. The search areas are set as described above, so that estimation accuracy of the positional deviation can be improved, and the search area can be set narrow for the input image close to the reference image. Therefore, the time required for the rough estimation processing of the positional deviation can be shortened, and the processing can be speeded up.

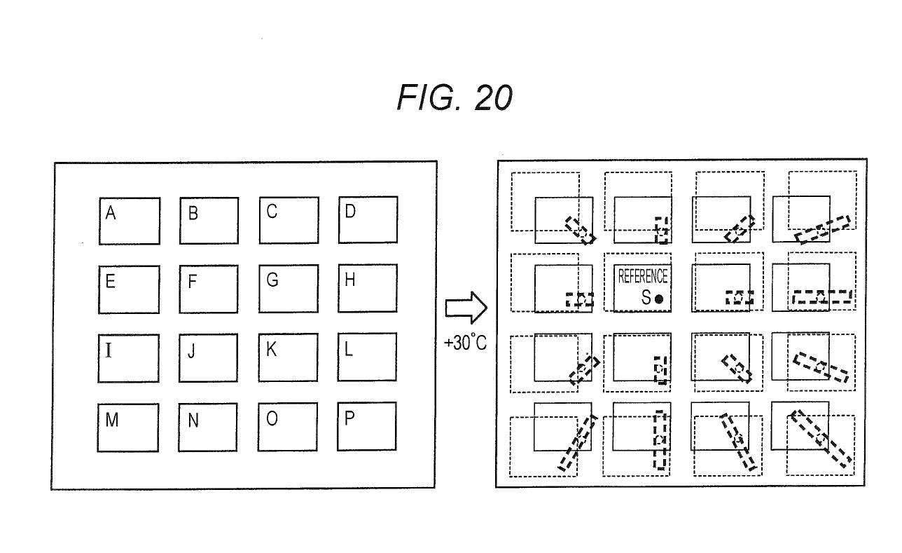

Note that the direction of the search area is not limited to the direction that accords with the direction of the input image, as illustrated in the examples, and may be a different direction, as illustrated in FIG. 20. That is, as illustrated in FIG. 20, the search area may be set to each input image in a direction according to the direction from the reference image. The search area is set in this way, so that the estimation accuracy of the positional deviation can be improved, and the narrowed search area along a radial direction can be obtained according to the direction from the reference image. Therefore, the time required for the rough estimation processing of the positional deviation can be shortened, and the processing can be speeded up.

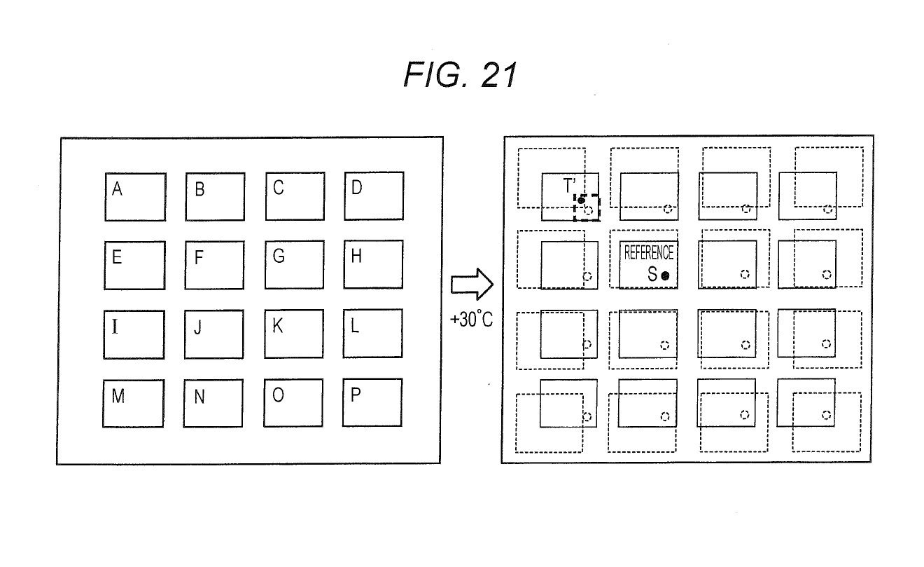

FIGS. 21 to 24 are diagrams illustrating a third example of positional deviation rough estimation processing. In the third example of the positional deviation rough estimation processing, first, one input image, of a group of input images, is employed as a second reference image, and search areas of other input images are set using a rough estimation result of positional deviation in the second reference image, as illustrated in the right diagram of FIG. 21. To be specific, template matching processing is performed within the set search area, based on a distance and a direction between a viewpoint (lens F) of a reference image F and a viewpoint (lens) of the second reference image, so that a pixel T′ is detected as a pixel having a highest degree of coincidence with a reference pixel S. As the second reference image, an input image close to the viewpoint of the reference image, and having a vector between the viewpoints, which has components in a diagonal direction (both in an X direction and in a Y direction), is selected. For the reference image F, an input image A is selected as the second reference image. Accordingly, the search area set to each input image can be narrowed as described below, the estimation accuracy of the positional deviation can be improved, and the processing can be speeded up.

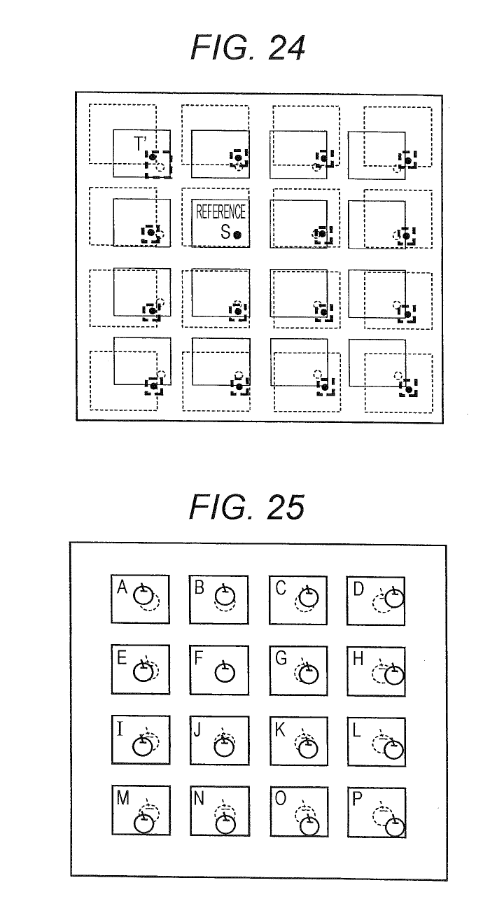

Next, as illustrated in FIG. 24, a pixel having a highest degree of coincidence with the reference pixel S is estimated for each input image other than the reference image and the second reference image, based on the pixel T′ in the second reference image (the black dots in FIG. 24). Then, a predetermined range based on the estimated pixel in each input image is set as the search area (the rectangles with bold dotted lines of FIG. 24).

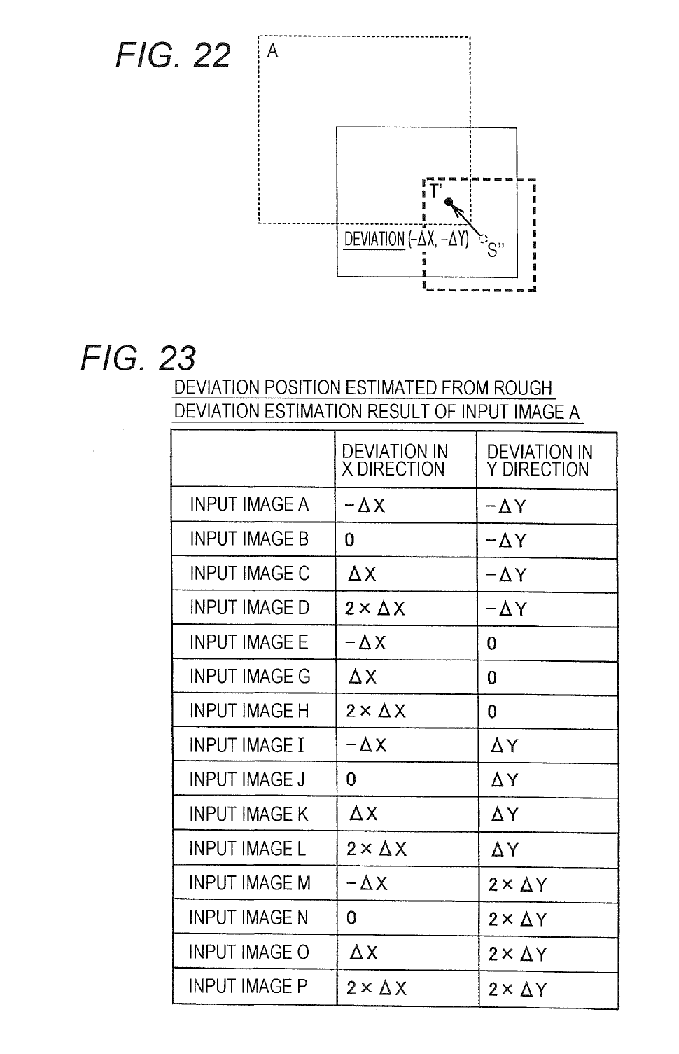

To be specific, referring to FIG. 22, a corresponding pixel S″ of a second reference image A of a case where the reference pixel S on the reference image F does not have positional deviation due to the temperature change is identified, and the search area (the rectangle with the bold dotted line in FIG. 22) is set from a distance and a direction between the viewpoints of the reference image F and the second reference image A, and a change amount (for example, 1/1000 times) of the pixel due to the temperature change (for example, ±30° C.), around the pixel S″. The template matching processing is performed in the search area using an image including the reference pixel S of the input image F, and the pixel T′ having the highest degree of coincidence with the reference pixel S is identified as a pixel being positioned corresponding to the reference pixel S.

Next, a pixel having the highest degree of coincidence with the reference pixel S in each input image is identified based on a positional relationship between the pixel S″ and the pixel T′, which is a result of the positional deviation rough estimation processing about the input image A. Here, as an example, positional relationships of the reference pixel on the reference image, in respective input images for each temperature change, are stored in advance, as illustrated in FIG. 23. Further, the result of the positional deviation rough estimation processing (the positional relationship between the pixel S″ and the pixel T′) is assigned to one of the positional relationships (the positional relationship of the input image A in this example), so that the search area is identified. Note that, in FIG. 23, the positional relationships of the respective input images are expressed in a table form. However, the positional relationships may be stored as a calculation formula of each input image.

Referring to FIG. 24, when the pixel having the highest degree of coincidence with the reference pixel S in each input image is identified, a predetermined area based on the pixel is set as the search area (the rectangles with the bold dotted lines). As an example, a range defined according to the temperature change in advance around the pixel may be set as the search area. Accordingly, the search area can be further narrowed. Therefore, the estimation accuracy of the positional deviation can be improved, and the processing can be speeded up.

FIGS. 25 to 30 are diagrams illustrating a fourth example of positional deviation rough estimation processing. In the fourth example of the positional deviation rough estimation processing, a search area is set in consideration of positional deviation based on a parallax from a reference image, which is set according to a distance between viewpoints of an input image serving as a reference image and other input images (lenses of a lens 22a), in addition to positional deviation due to temperature change.

FIG. 25 is a diagram illustrating a specific example of input images when there is a parallax. The example of FIG. 25 illustrates input images A to P of when an apple placed at a subject distance of 50 cm, on a background image having no parallax at an infinite distance. Referring to FIG. 25, while no parallax is caused on the background portion, positional deviation of a pixel is caused in the apple portion, which is similar to a case where the temperature is increased only in the apple portion (in an enlarging direction as a whole).

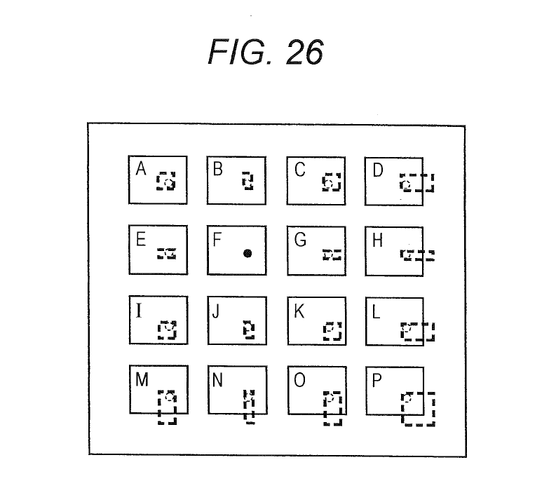

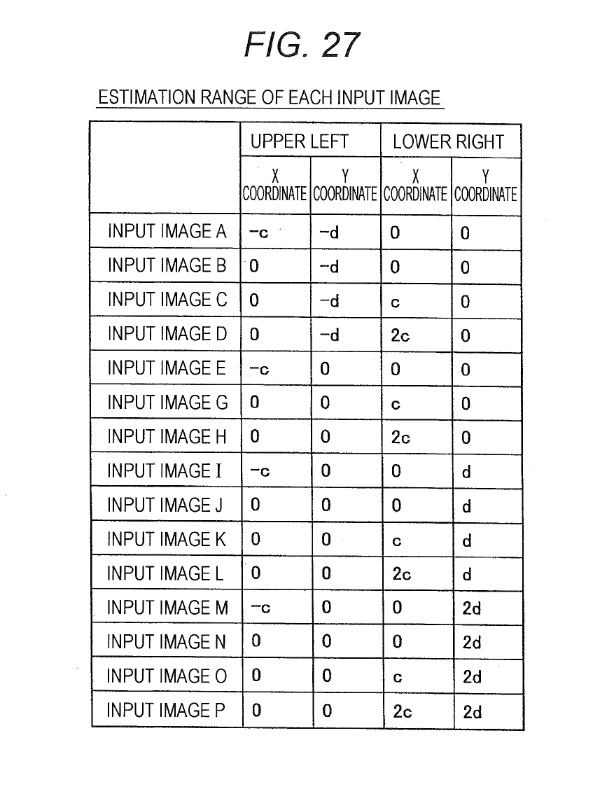

FIG. 26 is a diagram for describing a case of performing estimation of positional deviation according to a parallax, without considering temperature change for simple description. FIG. 27 is a diagram illustrating a specific example of search areas in coordinates, the search areas being set when the positional deviation according to a parallax is estimated. Referring to FIG. 26, even when the positional deviation according to a parallax is estimated, the search area (the rectangles with the bold dotted lines) is set to a pixel position (a pixel position of a case of no parallax) corresponding to a reference pixel on a reference image F of each input image, and template matching processing is executed in the search area, so that a pixel having a highest degree of coincidence is detected. Even in this case, as illustrated in FIG. 27, a search area (estimation range) for parallax in each input image may be defined in advance, or may be calculated using a calculation formula stored in advance. Note that the parallax occurs only in a direction into which an image as a whole is seen in an enlarged manner. Therefore, the search area for parallax is set having the pixel position of a case of no parallax as an end portion.

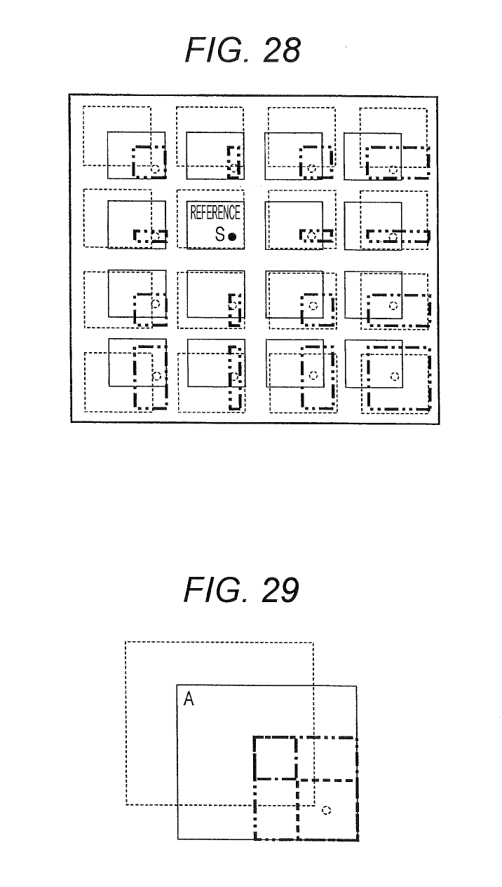

FIG. 28 is a diagram illustrating an example of search areas of when the positional deviation of a pixel is estimated in consideration of both of the parallax and the temperature change, and FIG. 29 is a diagram for describing thereof. Referring to FIGS. 28 and 29, when both of the parallax and the temperature change are considered, a range including (covering) both of a search area set (first search area) that is when the positional deviation due to the temperature change is estimated, and a search area (second search area) that is set when the positional deviation due to the parallax is estimated is set as the search area.

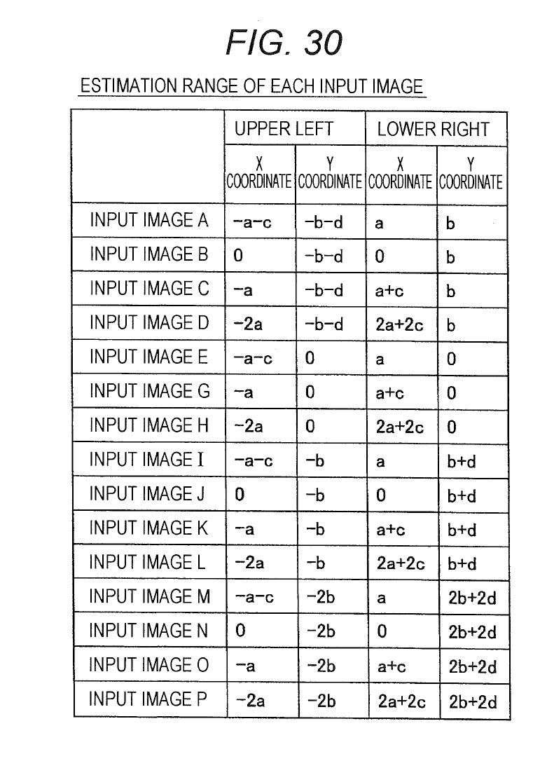

FIG. 30 is a diagram illustrating a specific example of search areas in coordinates, the search areas being set when the positional deviation of a pixel is estimated in consideration of both of a parallax and temperature change, and illustrating an example of when the search areas illustrated in FIG. 19 are set as the first search areas, and the search areas illustrated in FIG. 27 are set as the second search areas. Referring to FIG. 30, in this case, as an example, the search area can be a range obtained by addition of the first search area and the second search area (a range where the first search area and the second search area are circumscribed), as illustrated in FIG. 29.

Note that, as the above-described search area, a broader area than an area set from the range that covers the first search area and the second search area may be set, in consideration of deviation from a design value of actual lenses of the lens 22a, for example. Further, as illustrated in FIG. 20, the search area may be set in a direction that does not accord with the direction of the input image. Further, search areas of other input images may be set using a rough estimation result of the positional deviation in a second reference image, where one input image, of a group of input images, is set as the second reference image, as described in the third example of the positional deviation rough estimation processing.

[Second Modification]

As a second modification, an image processing device 1 may perform super-resolution processing in consideration of the degree of blur in each input image illustrated in FIGS. 5 and 7.

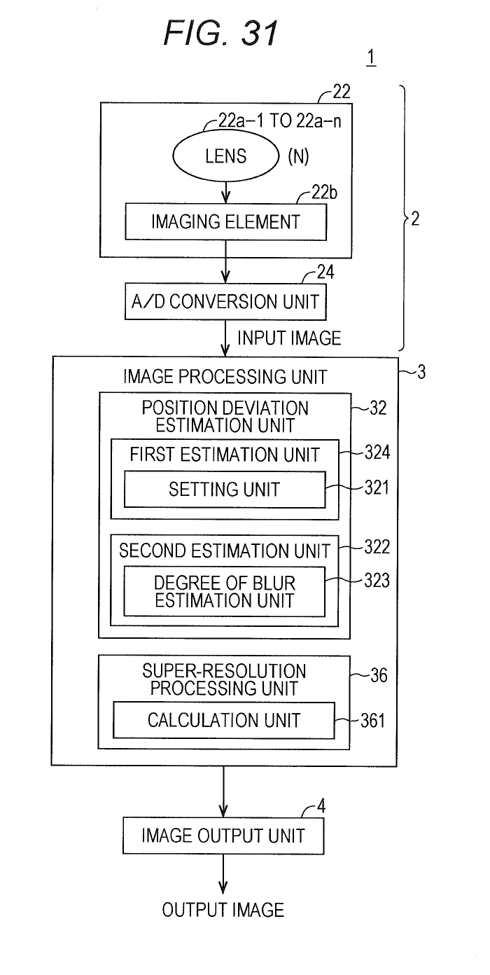

FIG. 31 is a block diagram illustrating a basic configuration of a configuration of the image processing device 1 according to the second modification.

Referring to FIG. 31, a second estimation unit 322 of the image processing device 1 includes a degree of blur estimation unit 323 for performing degree of blur estimation processing, in addition to the configuration of FIG. 1. The degree of blur estimation unit 323 performs the degree of blur estimation processing in second positional deviation estimation processing to estimate the degree of blur from a reference image, for each input image.

In the image processing device 1 according to the second modification, at step S2 described above, the degree of blur is also estimated when a deviation amount in units of sub-pixel (decimal pixel) is estimated. Then, at step S3 described above, the super-resolution processing is executed in consideration of a positional deviation amount and the degree of blur.

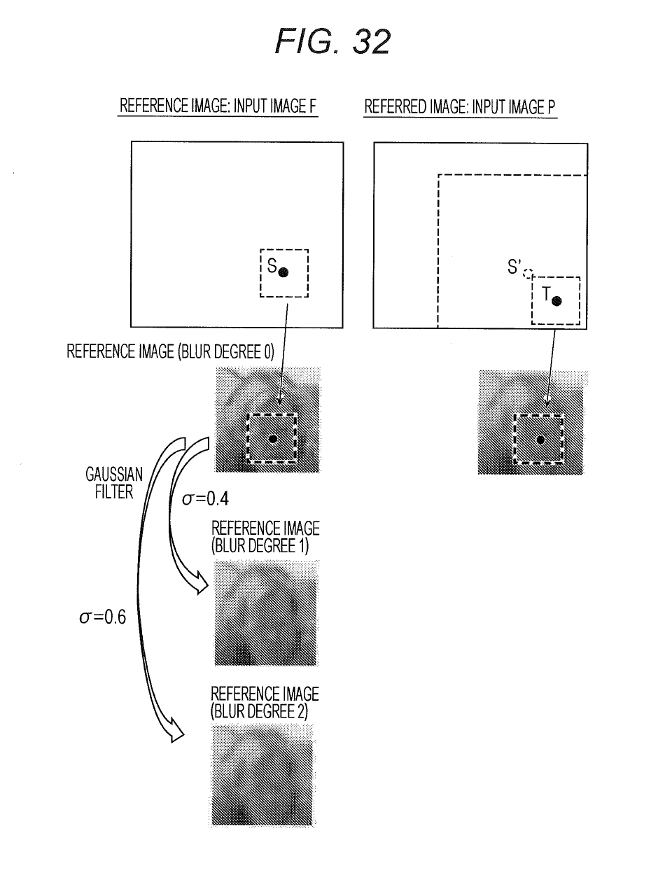

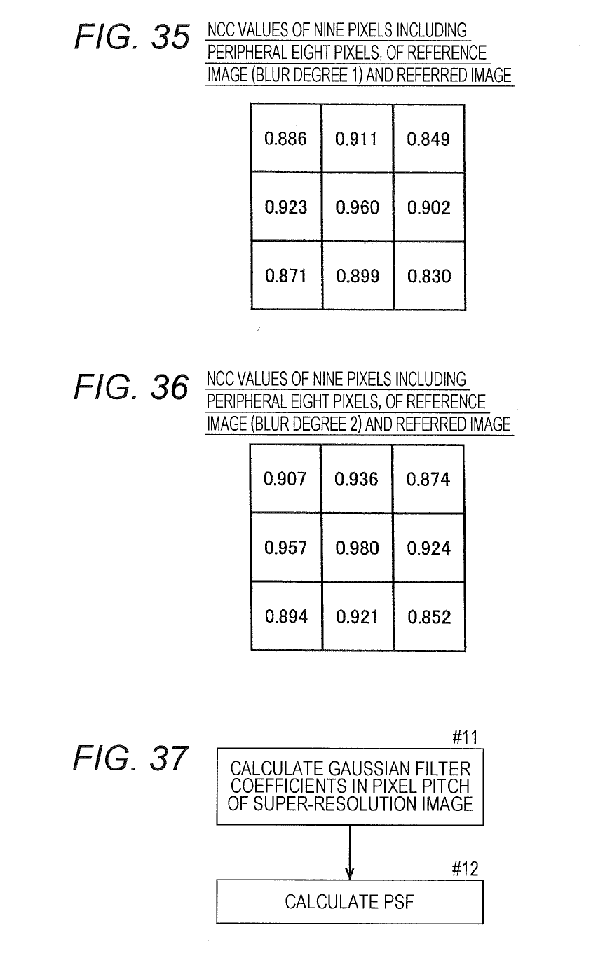

FIGS. 32 to 36 are diagrams for describing positional deviation estimation processing of when estimation of the degree of blur is further performed, the processing being executed at step S2 described above in the image processing device 1 according to the second modification. Referring to FIG. 32, at step S2 in the second modification, an image to which blur according to the degree of blur is added is generated, in addition to an image in a range including a reference pixel S in an input image F, as reference images, and the reference images are used in template matching processing. Then, as a result of the template matching processing using the plurality of reference images having different degrees of blur, positional deviation in units of sub-pixel is estimated in the reference image having the highest degree of coincidence (the degree of NCC), and a position in a referred image, and the degree of blur is also estimated.

In the example of FIG. 32, an image in which blur is added to the image of the input image F as “blur degree” of 1, and an image in which blur is added to the image of the input image F as “blur degree” of 2 are generated and used as reference images, in addition to an image in the input image F, where “blur degree” is 0. As a result of the template matching processing in a predetermined range (the rectangle with the dotted line) based on a pixel T, using the reference images, coordinates of a pixel having the highest degree of coincidence (for example, the highest NCC value) of each pixel are identified as a deviation amount, and the degree of blur indicating the reference image of that time is estimated as the degree of blur of the input image P in that position with respect to the input image serving as the reference image.

This is because, when the referred image is more blurred than the reference images, a blurred reference image (the reference image of the “blur degree” of 2 in the example of FIG. 32) is more similar to the referred image, and thus the degree of blur can be estimated. That is, similarity is higher when the positional deviation estimation processing is performed between images having a similar degree of blur. Therefore, the estimation accuracy of pixels becomes high.

Note that an example of a method of generating an image to which blur is added includes a method of applying a smoothing filter to the input image F. Examples of the smoothing filter include a Gaussian filter and an averaging filter. In the description below, a case of using a Gaussian filter will be exemplified. The Gaussian filter can be obtained by assigning coordinate values (x, y) and a constant σ that indicates the degree of blur to a following formula (1):

f(x,y)=exp{−(x²+y²)/2/σ²}/2π/σ² formula (1)

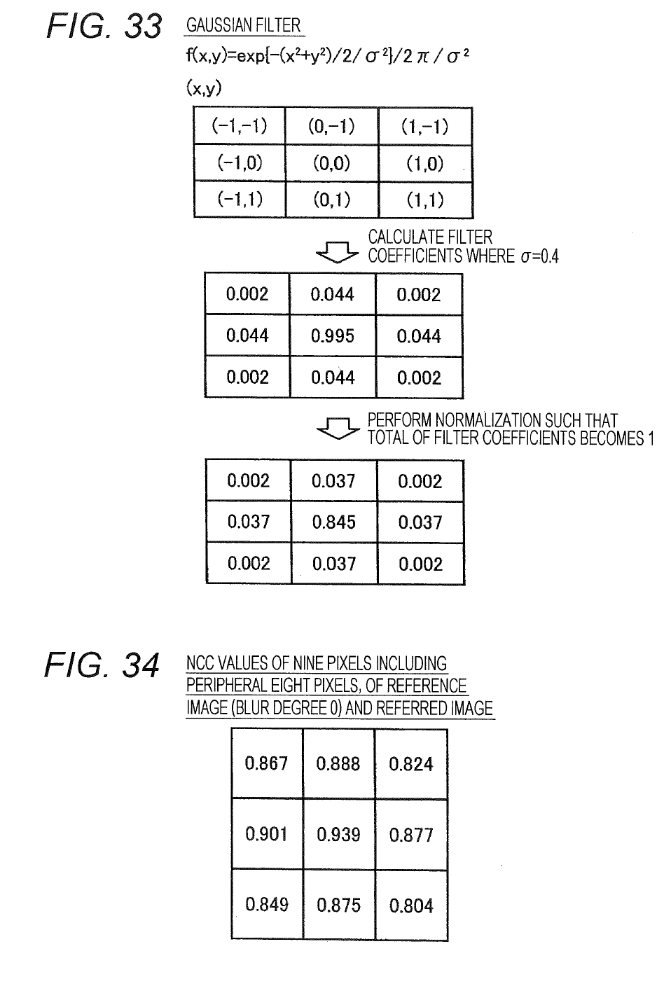

That is, referring to FIG. 33, to generate the reference image of the “blur degree” of 1, coefficients of the Gaussian filter are calculated where the constant σ=0.4. At this time, normalization is performed such that a total of the coefficients of the filter becomes 1. The filter with the coefficients is applied to the input image F that is the reference image having the “blur degree” of 0, so that the reference image (of the blur degree” of 1) having a different degree of blur is generated. Further, to generate a reference image of the “blur degree” of 2, in which blur is advanced, the coefficients of the Gaussian filter are calculated where the constant σ=0.6, similarly to the method illustrated in FIG. 33.

Note that FIG. 33 illustrates an example in which the size of the filter is 3×3 pixels. However, the size may be different depending on the way of selecting the constant σ. If the filter coefficients are close to 0 (for example, 0.01 or less), no substantial influence is provided to the filter processing. Therefore, the filter size is determined from the actual filter coefficients.

The NCC values that are the degrees of coincidence about respective pixels in a predetermined range based on the pixel T of the referred image (the predetermined range being a region of nine pixels including eight peripheral pixels around the pixel T) of when pattern matching processing is performed using the reference image of the “blur degree” of 0, the reference image of the “blur degree” of 1, and the reference, image of the “blur degree” of 2 are respectively obtained like FIGS. 34 to 36. In this case, the NCC value of a central pixel of when the reference image of the “blur degree” of 2 is used is the highest value in the NCC values. Therefore, the positional deviation amount is estimated based on the pixel, and the “blur degree” of 2 is estimated as the degree of blur of the referred image.

In the second modification, a parameter to be used in the super-resolution processing is calculated using the estimated degree of blur, prior to the super-resolution processing of step S3 described above. In the super-resolution processing, a parameter according to a pixel pitch after the super resolution is necessary. Therefore, the coefficients of the smoothing filter (Gaussian filter) according to a pixel pitch of the input image, which are used in the positional deviation estimation processing of step S2 described above, are converted according to a pixel pitch of the input image and an output image.

As a specific example, when the Gaussian filter is used to add blur, as the parameter to be used in the super-resolution processing, a point spread function (PSF) is used. FIG. 37 is a flowchart illustrating processing of calculating the parameter, which is performed prior to the super-resolution processing of step S3 described above. That is, referring to FIG. 37, first, the coefficients of the Gaussian filter used for addition of blur to the reference image having the highest NCC value in the positional deviation estimation processing of step S2 described above are converted into the pixel pitch of the image after the super-resolution processing, for each input image (step #11), and the PSF is calculated (step #12).

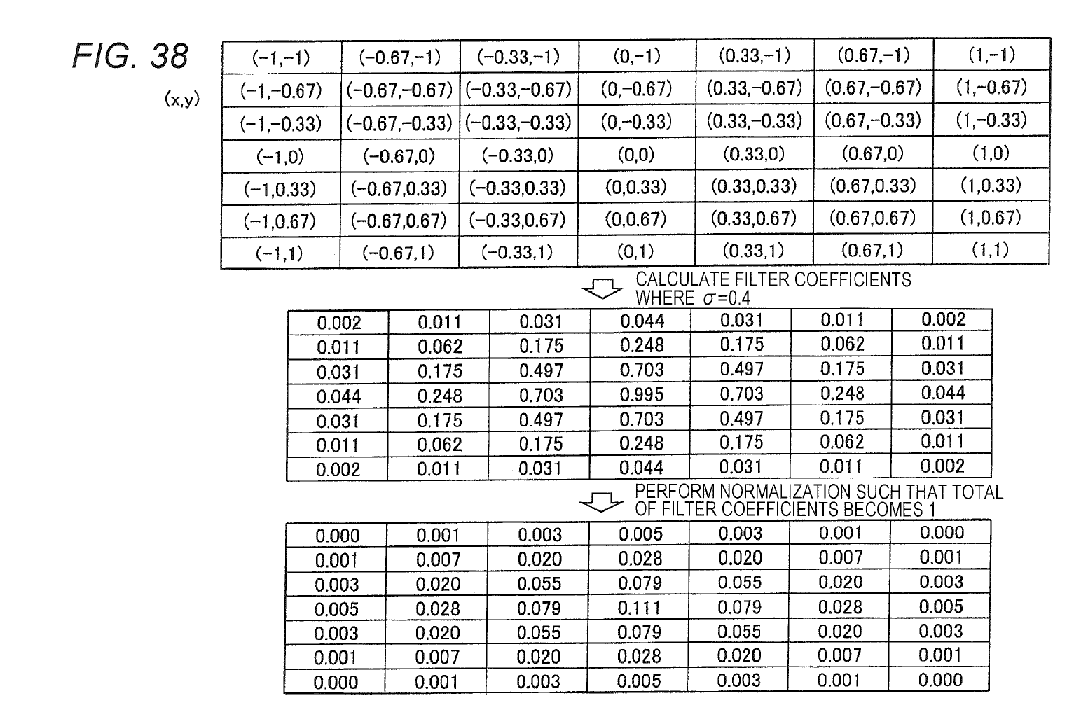

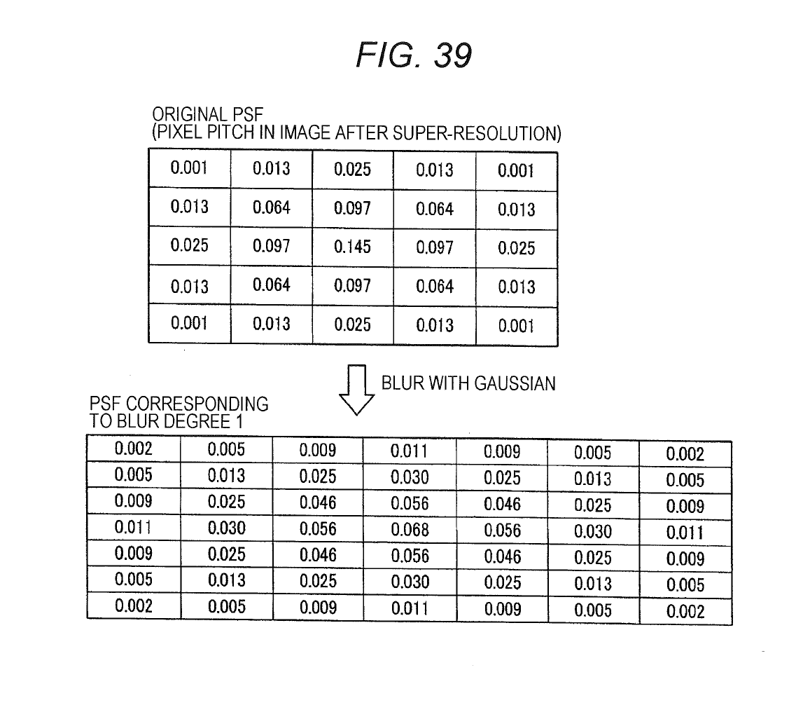

FIG. 38 is a diagram for describing a method of converting the coefficients of the Gaussian filter at step #11 described above. FIG. 39 is a diagram for describing a method of calculating the PSF at step #12 described above.

FIG. 38 illustrates a method of converting the coefficients of the Gaussian filter of when the number of pixels is caused to be three times in the vertical and horizontal directions in the super-resolution processing. Causing the number of pixels to be three times in the vertical and horizontal directions in the super-resolution processing corresponds to making the input image fine in a ⅓ pixel pitch. Therefore, it is necessary to calculate the coefficients of the Gaussian filter (FIG. 33, for example) in a ⅓ pixel interval used for addition of blur.

At this time, the same value of the constant σ, which indicates the degree of blur, is used. That is, in the case of σ=0.4, as illustrated in FIG. 38, coordinate values (x, y) in the ⅓ pixel interval and the constant σ=0.4, which indicates the “blur degree” of 1, are assigned to the above-described formula (1), so that the coefficients are calculated. Note that, here, a maximum value of the coordinate values (x, y) is 1. However, if the constant σ becomes large, a filter coefficient in the coordinate values of 1 or more, such as 1.33 or 1.67, becomes a value that cannot be ignored. Therefore, in that case, the coefficients are calculated using a filter size larger than the example illustrated in FIG. 38. Note that, as illustrated in FIGS. 14 to 16, when a down-sampling amount is ¼ in the deterioration information of super-resolution, the coefficients of the Gaussian filter are calculated in a ¼ pixel interval.

Next, referring to FIG. 39, the PSF defined in the pixel pitch of the super-resolution image of the “blur degree” of 0, based on a design value of a lens, is defined as illustrated in the upper diagram of FIG. 39. Then, this coefficient is treated similarly to the pixels, and the converted Gaussian filer of FIG. 38 is applied to the coefficient, so that the PSF that is a parameter corresponding to the “blur degree” of 1 is calculated. Note that, in this case, normalization is also performed such that a total of the filter coefficients becomes 1. The deterioration information is defined using the parameter calculated for each input image or each sub-region of the each input image, as described above, and the super-resolution processing is executed at step S3 described above.

The image processing device 1 in accordance with one or more embodiments can perform the super-resolution processing, for the group of input images, according to the positional deviation of a pixel due to the environmental condition (temperature change or the like), by executing the above-described processing. Accordingly, deterioration of image quality of each high-resolution image after the super-resolution processing due to the positional deviation of a pixel in each input image can be suppressed.

Further, the image processing device 1 sets the search area, based on the positional relationship between the viewpoint (lens) of the input image serving as the reference image, and the viewpoint (lens) of the at least one input image of the input images other than the reference image, and the environmental condition, in detecting the positional deviation of a pixel. Therefore, the image processing device 1 enables efficient search, can improve a processing speed, and can improve the estimation accuracy of the positional deviation.

Further, the image processing device 1 can perform the super-resolution processing, for the group of input images, according to the degree of blur of each input image with respect to one reference image of the group of input images, by estimating the degree of blur of each input image in the positional deviation estimation processing. Accordingly, the image processing device 1 can further suppress deterioration of image quality of the high-resolution image after the super-resolution processing due to the difference in the degree of blur of the input images.

It should be considered that the embodiments disclosed this time are exemplarily described in all aspects, and are not restrictive. The scope of the invention is indicated by the claims, instead of the above-described description, and it is intended to include all changes within the claims, and the meaning and the scope of equivalents.

Although the disclosure has been described with respect to only a limited number of embodiments, those skilled in the art, having benefit of this disclosure, will appreciate that various other embodiments may be devised without departing from the scope of the invention. Accordingly, the scope of the invention should be limited only by the attached claims.

### REFERENCE SIGNS LIST

1 Image processing device
2 Imaging unit
3 Image processing unit
4 Image output unit
22 Camera
22a Lens
22b Imaging element
24 Converter
32 Positional deviation estimation unit
36 Super-resolution processing unit
100 Digital camera
104 Digital processing circuit
106 Image processing circuit
108 Image display unit
112 Storage unit
114 Camera unit
200 Personal computer
202 Personal computer main body
204 Image processing program
206 monitor
208 mouse
210 Keyboard
212 External storage device
321 First estimation unit
322 Second estimation unit
323 Degree of blur estimation unit
324 Setting unit
361 Calculation unit

1-11. (canceled)

12. An image processing device that creates, from a group of multi-viewpoint input images having a common sub-region, a high-resolution image having higher frequency information than the input images, and outputs the high-resolution image, the image processing device comprising:
a controller comprising:
a setting unit that uses one input image of the group of input images, as a reference image, and sets a search area according to the reference image and based on an environmental condition, for each of the input images other than the reference image,
an estimation unit that estimates positional deviation of each of the input images other than the reference image with respect to the reference image, by performing template matching processing in the search area, using the reference image, and
a processing unit that executes super-resolution processing, for the input images, using the estimated positional deviation, as a parameter.

13. The image processing device according to claim 12, wherein the setting unit sets the search area, based on a positional relationship between the viewpoint of the input image serving as the reference image and the viewpoint of at least one input image of the input images other than the reference image, and the environmental condition.

14. The image processing device according to claim 13, wherein the setting unit sets the search area to each of the input images other than the reference image, the search area being identified from a distance and a direction between the viewpoint of the reference image, and a most distance viewpoint of the multi-viewpoints, and a deformation ratio defined in the environmental condition in advance.

15. The image processing device according to claim 13, wherein the setting unit sets the search area, based on distances and directions between the viewpoint of the input image serving as the reference image and the viewpoints of the respective input images other than the reference image, and the environmental condition.

16. The image processing device according to claim 13, wherein the setting unit uses the one input image of the input images other than the reference image, the one input image being selected according to the positional relationship with the viewpoint of the reference image, as a second reference image, and sets the search area for each of the input images other than the reference image and the second reference image, based on the positional deviation estimated for the second reference image.

17. The image processing device according to claim 12, wherein the setting unit uses the search area according to the reference image based on the environmental condition, as a first search area, and sets an area including the first search area and a second search area for searching for the positional deviation based on a parallax from the reference image, as the search area, the second search area being set according to distances from the viewpoint of the input image serving as the reference image to the viewpoints of the respective input images other than the reference image.

18. The image processing device according to claim 12, wherein the setting unit uses the input image having the viewpoint arranged at an inner side in the multi-viewpoints, of the group of input images, as the reference image.

19. The image processing device according to claim 12, further comprising:
a degree of blur estimation unit that estimates the degree of blur of the input images, by adding blur according to the degree of blur to the reference image and generating the reference image, and performing the template matching processing, wherein
the processing unit executes the super-resolution processing, further using the estimated degree of blur, as the parameter.

20. The image processing device according to claim 12, wherein the group of input images is an image group obtained with a lens array including a plurality of lenses having a mutually different optical axis.

21. An image processing method for generating, from a group of multi-viewpoint input images having a common sub-region, a high-resolution image having higher frequency information than the input images, as an output image, the method comprising:
using one input image of the group of input images, as a reference image, and setting a search area according to the reference image and based on an environmental condition, for each of the input images other than the reference image;
estimating positional deviation of each of the input images other than the reference image, with respect to the reference image, by performing template matching processing in the search area, using the reference image; and
executing super-resolution processing, for the input images, using the estimated positional deviation, as a parameter.

22. A non-transitory computer-readable recording medium storing an image processing program for causing a computer to execute processing of generating, from a group of multi-viewpoint input images having a common sub-region, a high-resolution image having higher frequency information than the input images, as an output image, the program for causing the computer to execute:
using one input image of the group of input images, as a reference image, and setting a search area according to the reference image and based on an environmental condition, for each of the input images other than the reference image;
estimating positional deviation of each of the input images other than the reference image, with respect to the reference image, by performing template matching processing in the search area, using the reference image; and
executing super-resolution processing, for the input images, using the estimated positional deviation, as a parameter.

23. The information processing device according to claim 12, wherein the setting unit sets the search area according to a positional relationship between the viewpoint of the reference image and the viewpoints of the input images other than the reference image, and a variation condition caused in at least the positional relationship, based on the environmental condition.

24. The information processing device according to claim 23, wherein the positional relationship includes relationships of mutual distances and directions.

25. The image processing method according to claim 21, wherein setting of the search area is executed according to a positional relationship between the viewpoint of the reference image and the viewpoints of the input images other than the reference image, and a variation condition caused in at least the positional relationship, based on the environmental condition.

26. The image processing method according to claim 25, wherein the positional relationship includes relationships of mutual distances and directions.

27. The non-transitory computer-readable recording medium storing an image processing program according to claim 22, wherein setting of the search area is executed according to a positional relationship between the viewpoint of the reference image and the viewpoints of the input images other than the reference image, and a variation condition caused in at least the positional relationship, based on the environmental condition.

28. The non-transitory computer-readable recording medium storing an image processing program according to claim 27, wherein the positional relationship includes relationships of mutual distances and directions.
